(19) United States
(12) Patent Application Publication
(10) Pub. No.: US 2026/0128829 A1
(43) Pub. Date: May 7, 2026

(54) METHODS FOR DETERMINING CONSISTENCY AND REPORTING WTRU-SIDE CONDITIONS FOR ARTIFICIAL INTELLIGENCE (AI)/MACHINE LEARNING (ML) POSITIONING

(71) Applicant: InterDigital Patent Holdings, Inc., Wilmington, DE (US)

(72) Inventors: Fumihiro Hasegawa, Westmount (CA); Yugeswar Deenoo Narayanan Thangaraj, Chalfont, PA (US); Shahab Hamidi-Rad, Sunnyvale, CA (US); Dylan Watts, Montreal (CA); Patrick Tooher, Montreal (CA)

(73) Assignee: InterDigital Patent Holdings, Inc., Wilmington, DE (US)

(21) Appl. No.: 18/936,471

(22) Filed: Nov. 4, 2024

(51) Int. Cl. H04L 5/00; H04W 24/10; H04W 64/00

(52) U.S. Cl. CPC H04L 5/0048; H04W 24/10; H04W 64/00

(57) ABSTRACT

A wireless transmit/receive unit (WTRU) comprises a processor configured to receive configuration information that may include a sounding reference signal (SRS) configuration. The processor may receive a first request to report a number of identifiers that the WTRU supports, send a first report that indicates the number of identifiers that the WTRU supports, send a second report that indicates a first set of identifiers, receive a second request to report one or more conditions of the WTRU, send a third report that indicates a second set of identifiers, and determine whether to send an SRS transmission based on whether one or more of the conditions of the WTRU have changed.

### BACKGROUND

An AI/ML model is trained, during a training phase, using measurements obtained from received downlink reference signals (DL-RS) and ground truth (e.g., WTRU locations). When the WTRU uses the trained AI/ML model, the received DL-RS should be transmitted from the network under the same condition as in the training phase. Otherwise, inconsistency compared to the training phase occurs, and the outcome of the AI/ML model may not be accurate or reliable.

Network side models are considered where the models are trained based on sounding reference signals (SRS) measurements. For example, gNB obtains SRS or SRSp measurements and uses the AI/ML model at the gNB to generate or infer a line of sight (LOS) indicator and/or timing measurements. In another example, location management function (LMF) obtains SRS or SRSp measurements made by the gNB and uses the AI/ML model at the LMF to generate the WTRU location.

When the WTRU's condition change (e.g., WTRU location, WTRU orientation, change of hardware) during training and/or inference phase, the SRS measurements made by the gNB also changes. The WTRU's condition change creates inconsistency between the training and the inference phase at the network and the change may affect the performance of gNB-side and/or LMF-side AI/ML models.

### SUMMARY

A wireless transmit/receive unit (WTRU) comprises a processor. The processor may be configured to receive configuration information. The configuration may include, for example, a sounding reference signal (SRS) configuration. The processor may be configured to receive a first request to report a number of identifiers that the WTRU supports. Each identifier may be associated with a condition of the WTRU. The processor may be configured to send a first report that indicates the number of identifiers that the WTRU supports. The processor may be configured to send a second report that indicates a first set of identifiers Each identifier in the first set of identifiers may indicate, for example, a value associated with a condition of the WTRU. The processor may be configured to receive a second request to report one or more conditions of the WTRU. The processor may be configured to send a third report that indicates a second set of identifiers. The second set of identifiers may indicate, for example, whether one or more of the conditions of the WTRU have changed. The processor may be configured to determine whether to send an SRS transmission based on whether one or more of the conditions of the WTRU have changed.

The first set of identifiers may indicate, for example, an orientation of the WTRU and a location of the WTRU. The first set of identifiers may indicate, for example, a hardware device used by the WTRU, a hardware condition or status of the WTRU, a time synchronization source, an absolute or relative location of transmission (Tx) or reception (Rx) panels, a time synchronization error at the WTRU, an angle of arrival (AoA) or angle of departure (AoD) alignment error at the WTRU, a phase alignment error at the WTRU, and/or beamforming techniques.

The hardware device may include, for example, the Tx panel, the Rx panel, amplifiers or filters. The hardware condition may include, for example, orientation of the Tx and/or Rx panel. The time synchronization source may include, for example, clock information from global navigation satellite system (GNSS) and/or clock information from the network. The time synchronization error at the WTRU may include, for example, timing drift and/or timing jitter.

The first request to report a number of associated IDs may be via a location management function (LMF).

The processor may be configured to determine to transmit the SRS transmission if the one or more of the conditions of the WTRU have not changed.

The processor may be configured to determine not to transmit the SRS transmission if the one or more of the conditions of the WTRU have changed.

The processor may be configured to receive a third request to report the conditions of the WTRU at indicated time instances. The indicated time instances may include, for example, absolute time, relative time and/or system frame number (SFN).

The processor may be configured to receive a third request to report the conditions of the WTRU periodically within a configured time window. The configured time window may include, for example, duration in terms of seconds, number of symbols, number of slots and/or number of frames.

A WTRU may be configured to perform a method that includes one or more of the following steps. The method may include receiving configuration information. The configuration may include, for example, a sounding reference signal (SRS) configuration. The method may include receiving a first request to report a number of identifiers that the WTRU supports. Each identifier may be associated with a condition of the WTRU. The method may include sending a first report that indicates the number of identifiers that the WTRU supports. The method may include sending a second report that indicates a first set of identifiers Each identifier in the first set of identifiers may indicate, for example, a value associated with a condition of the WTRU. The method may include receiving a second request to report one or more conditions of the WTRU. The method may include sending a third report that indicates a second set of identifiers. The second set of identifiers may indicate, for example, whether one or more of the conditions of the WTRU have changed. The method may include determining whether to send an SRS transmission based on whether one or more of the conditions of the WTRU have changed.

The first set of identifiers may indicate, for example, an orientation of the WTRU and a location of the WTRU. The first set of identifiers may indicate, for example, a hardware device used by the WTRU, a hardware condition or status of the WTRU, a time synchronization source, an absolute or relative location of transmission (Tx) or reception (Rx) panels, a time synchronization error at the WTRU, an angle of arrival (AoA) or angle of departure (AoD) alignment error at the WTRU, a phase alignment error at the WTRU, and/or beamforming techniques.

The hardware device may include, for example, the Tx panel, the Rx panel, amplifiers or filters. The hardware condition may include, for example, orientation of the Tx and/or Rx panel. The time synchronization source may include, for example, clock information from global navigation satellite system (GNSS) and/or clock information from the network. The time synchronization error at the WTRU may include, for example, timing drift and/or timing jitter.

The first request to report a number of associated IDs may be via a location management function (LMF).

The method may include determining to transmit the SRS transmission if the one or more of the conditions of the WTRU have not changed.

The method may include determining not to transmit the SRS transmission if the one or more of the conditions of the WTRU have changed.

The method may include receiving a third request to report the conditions of the WTRU at indicated time instances. The indicated time instances may include, for example, absolute time, relative time and/or system frame number (SFN).

The method may include receiving a third request to report the conditions of the WTRU periodically within a configured time window. The configured time window may include, for example, duration in terms of seconds, number of symbols, number of slots and/or number of frames.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example using an AI/ML model to estimate WTRU location according to an embodiment.

FIG. 3 is a system diagram illustrating an example associated ID and WTRU condition according to an embodiment.

FIG. 4 is a system diagram illustrating an example procedure for reporting behavior of WTRU conditions according to an embodiment.

FIG. 5 is a system diagram illustrating an example of hierarchical structure of SRS configuration parameters according to an embodiment.

FIG. 6 is a system diagram illustrating an example determination of SRS transmission based on consistency in WTRU conditions using the reference point according to an embodiment.

FIG. 7 is a system diagram illustrating an example determination of SRS transmission based on consistency in WTRU conditions using the previous SRS transmission occasion according to an embodiment.

FIG. 8 is a system diagram illustrating an example determination of consistency in WTRU conditions compared to the reported WTRU condition according to an embodiment.

FIG. 9 is a system diagram illustrating a first example of reporting WTRU side condition with a timestamp according to an embodiment.

FIG. 10 is a system diagram illustrating a second example of reporting WTRU side condition with a timestamp according to an embodiment.

FIG. 11 is a system diagram illustrating an example procedure for reporting the WTRU condition with a timestamp according to an embodiment.

### DETAILED DESCRIPTION

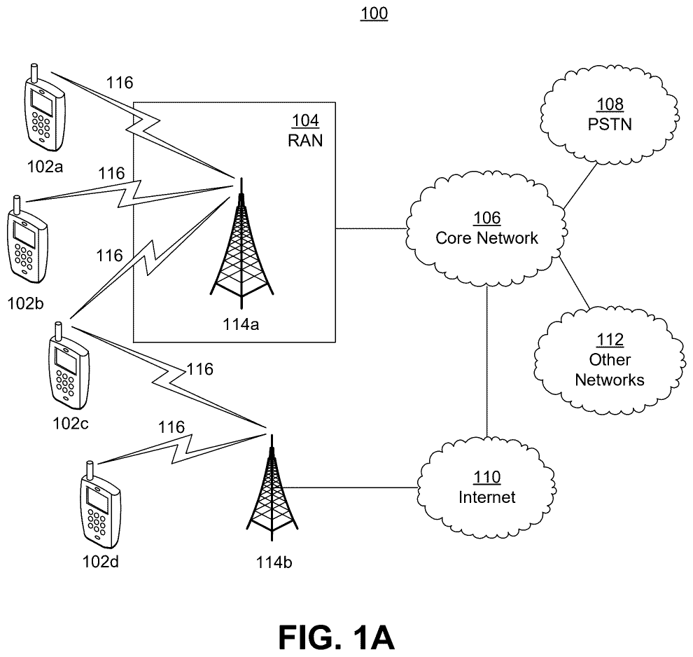

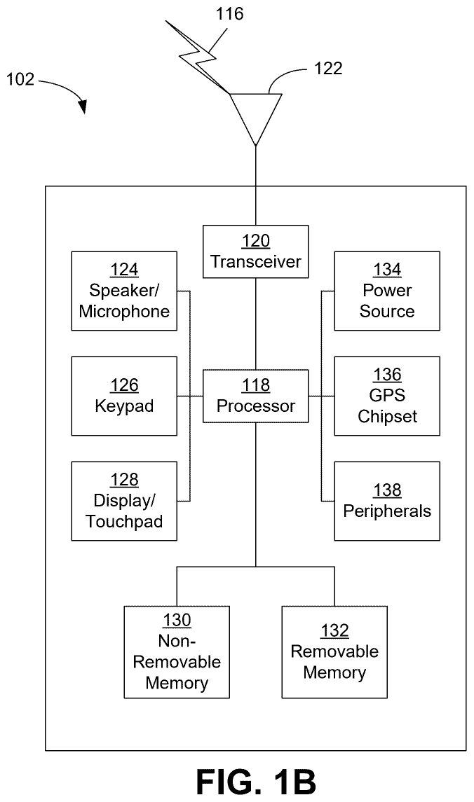

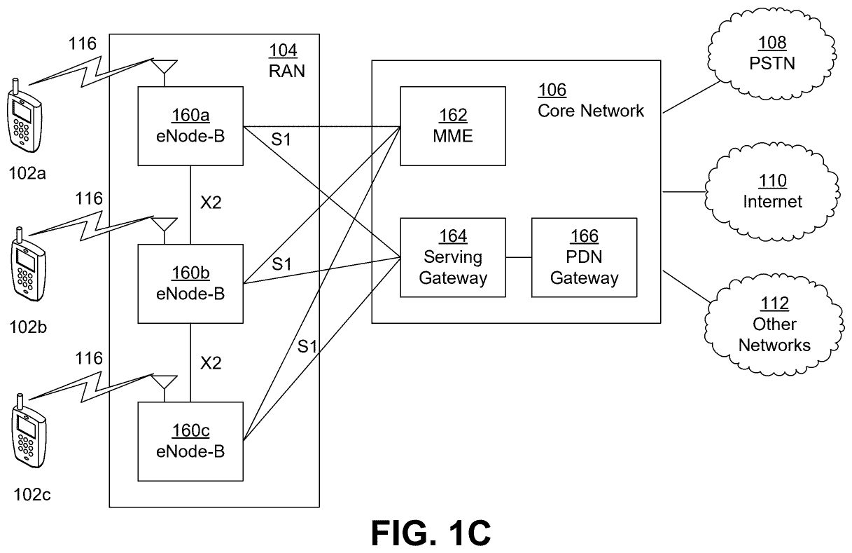

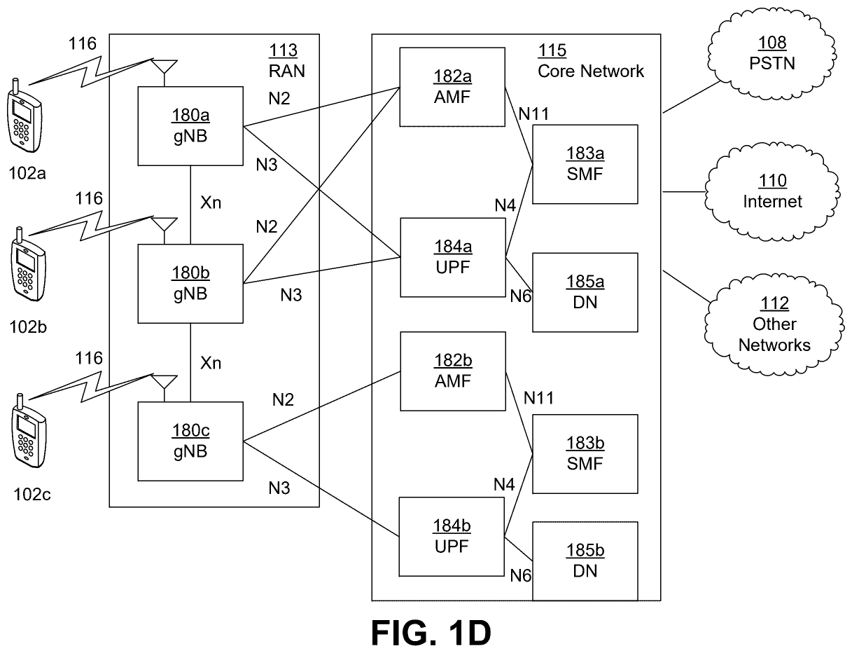

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some examples, the WTRU may associate the WTRU condition indicator with the WTRU condition. The WTRU may report the WTRU condition indicator if the WTRU receives a request to report the current condition. The WTRU may determine to transmit sounding reference signals (SRS) and/or cancel transmission of the SRS by comparing of WTRU conditions at the time of the SRS transmission and WTRU condition at the reference time. The WTRU may report a timestamp to indicate the WTRU condition. The WTRU may associate the ground truth with a WTRU condition indicator.

The WTRU may send a request to the network for configuration (e.g., DL-RS configurations, uplink reference signal (UL-RS) configurations) in physical uplink shared channel (PUSCH), physical uplink control channel (PUCCH), uplink control information (UCI), medium access control-control element (MAC-CE), radio resource control (RRC) and/or LTE positioning protocol (LPP) message. The request from the WTRU may include configurations of a measurement gap, DL-RS processing window and/or window for transmission of UL-RS. The WTRU may send an acknowledgement message in PUSCH and/or PUCCH for the grant received from the network.

More than one condition and/or criteria may be used in a combination. For example, the WTRU may be configured with more than one condition and/or associated WTRU behavior and the WTRU may determine which behavior the WTRU may use based on the applicable condition. The WTRU may measure DL-RS inside and/or outside of an active BWP. The WTRU may transmit UL-RS inside and/or outside of an active BWP. The WTRU may be preconfigured with parameters (e.g., measurement gaps, DL-RS processing windows, DL-RS configurations, and/or UL-RS configurations) via a semi-static message (e.g., LPP, RRC). The WTRU may report measurements and/or configuration parameters in a semi-static message (e.g., LPP, RRC) or dynamic message (e.g., UCI, MAC-CE). Actions the WTRU may determine to take may be configured by the network. For example, the WTRU may be configured with a rule and according to the rule, the WTRU may determine to take an associated action.

In addition to the measurements made on DL-RS, the WTRU may include at least one of the following cell-related measurements. For example, the WTRU may include synchronization signal block (SSB) reference signal received power (RSRP) from the serving cell with corresponding cell ID. The WTRU may include SSB RSRP from the neighboring cell(s) with corresponding cell ID(s). The WTRU may include RSRP of channel state information-reference signals (CSI-RS) with CSI-RS resource ID. The WTRU may include RSRP of demodulation reference signals (DM-RS).

The term “network” may include access and mobility management function (AMF), location management function (LMF), next generation node B (gNB) or next generation radio access network (NG-RAN). The terms “pre-configuration” and “configuration” may be used interchangeably. The terms “non-serving gNB” and “neighboring gNB” may be used interchangeably. The terms “gNB” and “transmission/reception point (TRP)” may be used interchangeably. The terms “DL-RS” and “DL-RS resource” may be used interchangeably. The terms “DL-RS(s)” and “DL-RS resource(s)” may be used interchangeably, where DL-RS(s) and DL-RS resource(s) may belong to different DL-RS resource sets. The terms “Measurement gap” or “Measurement gap pattern” may be used interchangeably. “Measurement gap pattern” may include parameters such as measurement gap duration or measurement gap repetition period or measurement gap periodicity.

A LMF may be a non-limiting example of a node or entity (e.g., network node or entity) that may be used for and/or to support positioning or sensing. Other nodes and/or entity may be substituted for LMF and still be consistent with the methods and apparatuses described herein. The WTRU may receive a preconfigured threshold(s) from the network (e.g., LMF, gNB).

The LOS indicator may be a hard (e.g., 1 or 0) or a soft indicator (e.g., 0, 0.1, 0.2. . ., 1) and the LOS indicator may indicate the likelihood of the presence of an LOS path between a TRP and a WTRU and/or along DL-RS. The LOS indicator may be associated with a TRP or positioning reference signal (PRS) resource ID (e.g., index). The WTRU may receive the LOS indicator from the network per TRP and/or resource ID. Alternatively and/or additionally, the WTRU may determine the LOS indicator per TRP and/or resource ID based on measurements.

The terms ID” and “index” may be used interchangeably. The terms “training” and “data collection” may be used interchangeably. The terms “SRS”, “SRSp” or “SRS for positioning may be used interchangeably. The terms “WTRU-side condition”, “WTRU condition” or “WTRU implementation” may be used interchangeably.

A WTRU location may be expressed, for example, in terms of altitude, latitude, geographic coordinate, and/or local coordinate. A timestamp may be indicated, for example, by absolute time, relative time (e.g., in seconds) compared to a reference time, system frame number (SFN), slot index, frame index, subframe index and/or symbol index. “Absolute time” may be, for example, coordinated universal time (UTC) time, global navigation satellite system (GNSS) time, and/or locally defined absolute time (e.g., long term evolution (LTE) and/or new radio (NR) Time).

The WTRU may receive configurations for a time window, for example, such as duration (e.g., expressed in terms of seconds, number of symbols, number of slots, number of frames, number of subframes), start and/or end time (e.g., expressed in terms of absolute time, system time, relative time with respect to a reference time indicated by the network or determined by the WTRU, SFN index, slot index, symbol index, frame index, subframe index). The WTRU may receive more than one configurations of a time window where each configuration is associated with an index. The time window may be initiated with a trigger sent by the network. For example, the WTRU may receive a command (e.g., DCI) to initiate an indicated time window, indicated via the configuration index. The WTRU may determine to initiate the time window after a configured duration after reception of the command (e.g., N symbols, N slots, N frames, N seconds). The WTRU may receive an activation or deactivation command (e.g., DCI, MAC-CE) to activate or deactivate the time window, respectively, from the network.

Configurations for reference signals (RSs) may be implemented. In one example, the WTRU may receive DL-RS and/or UL-RS (e.g., SRS) configurations for positioning purpose from the network (e.g., LMF). The LMF may forward the PRS configuration and SRS configurations to the gNB so that the gNB can schedule PRS transmission or SRS reception at the TRP, transmission point (TP) and/or reception point (RP).

In some examples, a DL-RS configuration may contain at least one of the following parameters. For example, a DL-RS configuration may contain number of symbols. A DL-RS configuration may contain transmission power. A DL-RS configuration may contain a number of DL-RS resources included in DL-RS resource set. A DL-RS configuration may contain a muting pattern for DL-RS (e.g., the muting pattern may be expressed via a bitmap) A DL-RS configuration may contain a periodicity type of DL-RS (e.g., periodic, semi-persistent, or aperiodic). A DL-RS configuration may contain a slot offset for periodic transmission for DL-RS. A DL-RS configuration may contain a vertical shift of DL-RS pattern in the frequency domain. A DL-RS configuration may contain a time gap during repetition. A DL-RS configuration may contain a repetition factor. A DL-RS configuration may contain a RE resource element (RE) offset. A DL-RS configuration may contain a comb pattern and/or comb size. A DL-RS configuration may contain a spatial relation (e.g., with respect to other DL-RSs or UL-RSs such as SRS for positioning purpose). A DL-RS configuration may contain a quasi co-location (QCL) information (e.g., QCL target and/or QCL source) for DL-RS. A DL-RS configuration may contain a number of TRPs. A DL-RS configuration may contain an absolute radio-frequency channel number (ARFCN). A DL-RS configuration may contain a subcarrier spacing. A DL-RS configuration may contain an expected reference signal time difference (RSTD) and/or an uncertainty in expected RSTD. A DL-RS configuration may contain a start Physical Resource Block (PRB). A DL-RS configuration may contain a bandwidth, bandwidth part (BWP) ID and/or a number of frequency layers. A DL-RS configuration may contain a start and/or end time for DL-RS transmission. A DL-RS configuration may contain an on and/or off indicator for DL-RS. A DL-RS configuration may contain a TRP ID, DL-RS ID, cell ID, and/or global cell ID. A DL-RS configuration may contain an applicable time window. The WTRU may apply a DL-RS configuration under a condition that the current time is within the applicable time window. “ID” may be used interchangeably with “index”. DL-RS may include, for example, CSI-RS, phase tracking reference signal (PTRS), PRS, tracking reference signal (TRS), and/or SSB.

In one example, UL-RS and/or SRS configuration may include at least one of the following. For example, UL-RS and/or SRS configuration may include resource ID. UL-RS and/or SRS configuration may include comb offset values and/or cyclic shift values. UL-RS and/or SRS configuration may include a start position in the frequency domain. UL-RS and/or SRS configuration may include a number of UL-RS symbols. UL-RS and/or SRS configuration may include a shift in the frequency domain for UL-RS. UL-RS and/or SRS configuration may include a frequency hopping pattern UL-RS and/or SRS configuration may include a type of UL-RS (e.g., aperiodic, semi-persistent or periodic). UL-RS and/or SRS configuration may include a sequence ID used to generate UL-RS, and/or other IDs used to generate UL-RS sequence. UL-RS and/or SRS configuration may include spatial relation information, indicating which reference signal (e.g., DL RS, UL RS, CSI-RS, SRS, DM-RS) or SSB (e.g., SSB ID, cell ID of the SSB) the UL-RS is related to spatially where the UL-RS and DL RS may be aligned spatially. UL-RS and/or SRS configuration may include QCL information (e.g., a QCL relationship between UL-RS and other reference signals or SSB). UL-RS and/or SRS configuration may include QCL type (e.g., QCL type A, QCL type B, QCL type C, QCL type D). UL-RS and/or SRS configuration may include a resource set ID. UL-RS and/or SRS configuration may include a list of UL-RS resources in the resource set. UL-RS and/or SRS configuration may include transmission power related information. UL-RS and/or SRS configuration may include pathloss reference information which may contain index for SSB, CSI-RS or DL-RS. UL-RS and/or SRS configuration may include the periodicity of UL-RS transmission. UL-RS and/or SRS configuration may include spatial information such as spatial direction information of UL-RS transmission (e.g., beam information, angles of transmission), and/or spatial direction information of DL RS reception (e.g., beam ID used to receive DL RS, angle of arrival). “ID” may be used interchangeably with “index”. UL-RS may include, for example, SRS and SRS for positioning purpose.

The following categories of WTRU positioning techniques may be implemented. For example, a “DL positioning method” may refer to a positioning method that uses downlink reference signals such as PRS. The WTRU receives multiple reference signals from TP(s) and measures DL RSTD and/or RSRP.

Examples of DL positioning methods are DL angle of departure (DL-AoD) or DL time difference of arrival (DL-TDOA) positioning.

For example, a “UL positioning method” may refer to a positioning method that uses uplink reference signals such as SRS for positioning. The WTRU transmits SRS to multiple RPs and the RPs measure the UL relative time of arrival (UL-RTOA) and/or RSRP. Examples of UL positioning methods are UL-TDOA or UL angle of arrival (UL-AoA) positioning.

For example, a “DL & UL positioning method” may refer to any positioning method that uses both uplink and downlink reference signals for positioning. In one example, a WTRU may transmit SRS to multiple TRPs and gNB measures reception-transmission (Rx-Tx) time difference which is calculated based on the time of arrival of DL-RS (e.g., PRS). The gNB may measure RSRP for the received SRS. The WTRU may measure Rx-Tx time difference for PRS transmitted from multiple TRPs. The WTRU may measure RSRP for the received PRS. The Rx-TX difference and/or possibly RSRP measured at WTRU and gNB are used to compute round trip time. Here “WTRU Rx-Tx time difference” refers to the difference between arrival time of the reference signal transmitted by the TRP and transmission time of the reference signal transmitted from the WTRU. An example of DL & UL positioning method is multi round trip time (RTT) positioning.

AI for positioning may be implemented. Artificial intelligence may be broadly defined as the behavior exhibited by machines that mimics cognitive functions to sense, reason, adapt, act, and providing the ability to discern patterns.

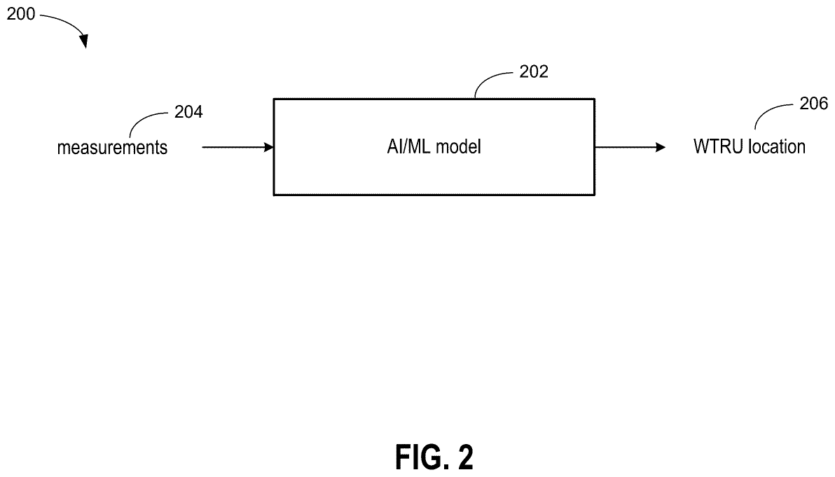

An example of using an AI/ML model to obtain WTRU location is shown in FIG. 2. As shown in diagram 200, the WTRU inputs the AI/ML model 202 with measurements 204 (e.g., timing, phase, power measurements such as RSTD, time of flight, time of arrival (ToA), time of departure (ToD), carrier phase measurement, carrier phase difference measurement, RSRP, RSRP per path) and the WTRU obtains an inference (e.g., the WTRU location 206) from the AI/ML model. The output of the AI/ML model 202 may be referred to as “inference”.

As an input to the AI/ML model 202, if the AI/ML model 202 is associated with or trained with measurements from more than one TRPs and the WTRU has an AI/ML model, the WTRU may use measurements made from more than one TRPs. If the AI/ML model is trained with measurements from more than one TRPs, the WTRU may receive an indication and/or configuration from the network about identification information about the TRPs (e.g., TRP IDs and/or PRS IDs) the AI/ML model is trained with.

Inputs for an AI/ML model for positioning may be at least one or combination of the following. For example, an input for an AI/ML model for positioning may be RSRP of PRS resource(s). An input for an AI/ML model for positioning may be statistical measure of RSRP (e.g., mean, variance etc.) per PRS resource(s). An input for an AI/ML model for positioning may be maximum or minimum value of RSRP per PRS resource(s). An input for an AI/ML model for positioning may be RSRP of PRS resource(s) per path and/or RSRP of PRS resource(s) per antenna port. An input for an AI/ML model for positioning may be Reference Signal Carrier Phase (RSCP) of PRS resource(s) per path and/or RSCP of PRS resource(s) per antenna port. An input for an AI/ML model for positioning may be RSTD and/or RSCP Difference (RSCPD) of PRS resource(s). An input for an AI/ML model for positioning may be statistical measure of RSTD per PRS resource(s). An input for an AI/ML model for positioning may be maximum or minimum value of RSTD per PRS resource(s). An input for an AI/ML model for positioning may be RSTD and/or RSCPD of PRS resource(s) per path and/or RSTD and/or RSCPD of PRS resource(s) per antenna port. An input for an AI/ML model for positioning may be time of arrival per PRS resource(s), time of arrival per PRS resource(s) per path, and/or time of arrival per PRS resource(s) per port. An input for an AI/ML model for positioning may be statistical measure of Time of arrival per PRS resource(s). An input for an AI/ML model for positioning may be maximum or minimum value of time of arrival per PRS resource(s). An input for an AI/ML model for positioning may be channel impulse response (CIR) estimated based on DL-RS(s) (e.g., PRS, CSI-RS, DM-RS) where CIR may be associated with a TRP or TRPs. An input for an AI/ML model for positioning may be a power delay profile (PDP) estimated based on DL-RS(s) (e.g., PRS, CSI-RS, DM-RS) where CIR may be associated with a TRP or TRPs. An input for an AI/ML model for positioning may be a delay profile (DP) estimated based on DL-RS(s) (e.g., PRS, CSI-RS, DM-RS) where CIR may be associated with a TRP or TRPs.

The WTRU may report associated ID. For example, the WTRU may report a WTRU condition indicator (e.g., associated ID) which corresponds to the WTRU condition. The WTRU may determine to transmit SRS or cancel SRS transmission if the WTRU condition is similar to the WTRU condition at the reference time.

Determination of indication of implementation may be implemented. In one example, the WTRU may receive a request from the network (e.g., LMF and/or gNB) to report supported variations of implementation or WTRU-side conditions (e.g., orientation angle). WTRU conditions may be, for example, at least one of the following. For instance, WTRU conditions may be the orientation of the WTRU. WTRU conditions may be the location of the WTRU. WTRU conditions may be the hardware (e.g., Tx or Rx panel, amplifiers, filters) used by the WTRU. WTRU conditions may be the hardware condition or status (e.g., orientation of a panel). WTRU conditions may be the time synchronization source (e.g., clock information from GNSS, clock information from the gNB). WTRU conditions may be the absolute or relative location of Tx or Rx panels. WTRU conditions may be the time synchronization error at the WTRU (e.g., timing drift, timing jitter). WTRU conditions may be the AoA or AoD alignment error at the WTRU. WTRU conditions may be the phase alignment error at the WTRU. WTRU conditions may be the beamforming techniques (e.g., analogue, digital).

In one example, a WTRU condition may be associated with a WTRU condition indicator, such as an associated ID. In another example, more than one WTRU condition may be associated with an associated ID. In one example, the WTRU may determine association between an associated ID and WTRU condition(s). The WTRU may not indicate the relationship between associated IDs and WTRU conditions to the network.

A WTRU implementation or WTRU-side condition may be represented by a WTRU condition indicator (e.g., associated ID). The WTRU may receive a request, from the network, to report at least one of the following. For example, the WTRU may receive a request to report the number of associated IDs supported by the WTRU. For instance, the WTRU may report a range of associated ID (e.g., from associated ID#1 to associated ID#N) or the number of associated IDs (e.g., N=3) to the network. For example, the WTRU may receive a request to report the associated IDs from preconfigured or configured list of associated IDs. For instance, the WTRU may receive a list of associated IDs from the network. The WTRU may also receive a look up table indicating an associated ID with an implementation (e.g., associated ID#1 indicates analogue beamforming, associated ID#2 indicates digital beamforming). The WTRU may report to the network a subset of the associated IDs which are supported by the WTRU.

In one example, the WTRU may receive, from the network, a look-up table associating a WTRU condition (e.g., orientation angle) and associated ID. In another example, the WTRU may determine the association of WTRU condition and associated ID. The WTRU may report to the network that the WTRU determined the association of WTRU conditions and associated IDs.

The WTRU may report, to the network, associated IDs in a semi-static (e.g., RRC, LPP) and/or dynamic message (e.g., UCI, MAC-CE). The WTRU may receive the request from the network in a semi-static (e.g., RRC, LPP) or dynamic message (e.g., DCI, MAC-CE). In one example, the WTRU may receive a request, from the network, the minimum or maximum number of associated IDs to report. For example, the WTRU may receive a request from the network to report up to N=3 associated IDs. In one example, the WTRU may receive a request to report WTRU conditions explicitly. For example, the WTRU may receive a request from the network to report the WTRU location. The WTRU may determine to use radio access technology (RAT) dependent (e.g., DL-TDOA) and/or RAT independent (e.g., GNSS, GPS) positioning method(s) to determine the WTRU location.

A WTRU condition indicator may be implemented. The WTRU condition indicator (e.g., associated ID) may be used by the network to determine whether the condition at the WTRU is same or different between two time instances. Knowledge of similarity of WTRU conditions may be useful for the network when using an AI/ML model to generate inference (e.g., WTRU location). In one example, the network may use SRS measurements to train an AI/ML model during the training phase. The network may use SRS measurements as an input to the AI/ML model and generate inference during the inference phase. Therefore, knowledge of WTRU conditions during SRS transmission may be important for the network to determine consistency between the measurements used in the training phase and inference phase.

If the WTRU condition during the inference phase is different from the WTRU condition during the training phase, the inference generated by the AI/ML model may not be reliable. The trained model may yield an unexpected inference, due to a mismatch in WTRU conditions between training and inference phase, causing degradation in the performance of the AI/ML model.

The WTRU may associate an associated ID with an SRS resource ID and report, to the network, the association (e.g., associated ID and SRS resource ID that is associated with the associated ID). The WTRU may transmit the SRS at a time instance. At a different time instance, the WTRU may transmit the SRS and report the association to the network. If reported associated IDs match between different time instances, the network may determine that the WTRU conditions between two different time instances of transmission of SRS are similar.

Reporting behavior of WTRU conditions may be implemented. In one example, the WTRU may receive a request form the network to report the WTRU-side condition. The WTRU may report an associated ID as a response for the request. In one example, if the WTRU's condition is aligned, same or similar to the already reported WTRU condition and if the WTRU reported the associated ID corresponding to the reported condition, the WTRU may determine to report the corresponding associated ID.

In some examples, if the WTRU's condition is different from the reported WTRU condition (e.g., a set of WTRU conditions, a set of associated IDs), the WTRU may determine to report the different associated ID. For example, the WTRU may report an associated ID which has not been reported to the network. The WTRU may determine the associated ID to report in the ascending order. For example, if the WTRU has already reported associated ID#1, and the WTRU condition is different from the condition associated with the associated ID#1, the WTRU may determine to report associated ID#2.

In some examples, if this is the first time the WTRU receives the request to report the WTRU condition (e.g., a set of WTRU conditions is empty), the WTRU may report an associated ID to the network. The WTRU may receive, from the network, a configuration and/or indication which associated ID to report first. In one example, the WTRU may determine to report the WTRU condition if the WTRU has never reported the WTRU condition and/or a set of reported WTRU condition(s) is empty.

In some examples, the WTRU may receive a schedule to report the WTRU condition. For example, the WTRU may receive, from the network, a request to report WTRU conditions at an indicated time instance(s) (e.g., absolute time, relative time, SFN). The WTRU may determine the WTRU condition (e.g., WTRU orientation) at the indicated time instance (e.g., absolute time). The WTRU may report the WTRU condition at indicated or configured reporting occasions. The time instance may be represented by absolute or relative time (e.g., N slots, N seconds from a reference time or time the WTRU receives the request).

In one example, the WTRU may receive a request to report WTRU conditions periodically. The WTRU may report the WTRU condition periodically within a configured time window. The WTRU may receive configurations for the time window such as duration (e.g., in terms of seconds, number of symbols, number of slots, and/or number of frames), start and/or end time (e.g., absolute time, relative time with respect to a reference time, SNF index, slot index, symbol index, and/or frame index). In one example, the WTRU may receive an aperiodic (e.g., one-time) request from the network to report the WTRU condition.

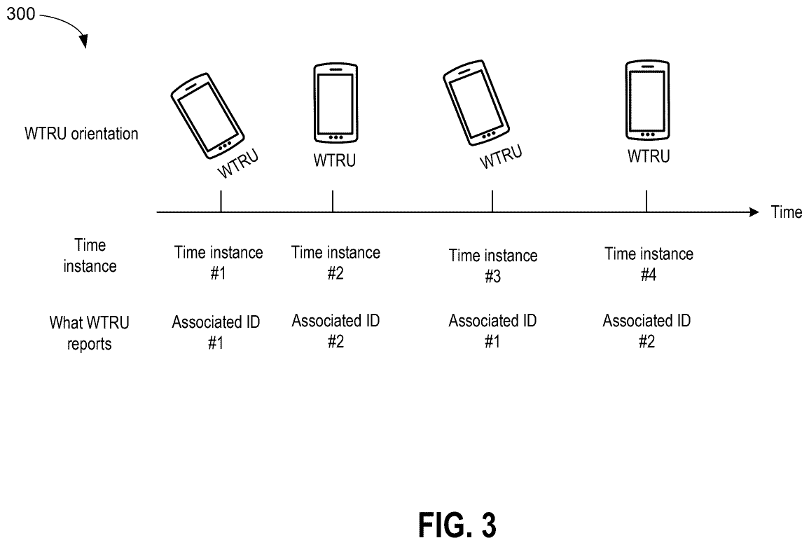

FIG. 3 is an example associated ID and WTRU condition. In diagram 300, orientation of the WTRU is used as an example of a WTRU condition. In the example, the WTRU receives a request from the network at indicated time instances (e.g., time instance #1). At each time instance, depending on the WTRU orientation, the WTRU reports the corresponding associated ID. For example, at time instance #1, the WTRU reports Associated ID#1 to the network since it is the first time the WTRU reports an associated ID. The WTRU may receive an indication from the network to start from Associated ID#1. At time instance #2, the WTRU reports Associated ID#2 since orientation angle is different from the reported WTRU condition from the past (e.g., time instance #1). At time instance #3, the WTRU reports an Associated ID#1 since the WTRU orientation is same as the WTRU orientation at time instance #1. At time instance #4, the WTRU reports Associated ID #2 since the WTRU orientation is the same as the orientation at time instance #2.

In some examples, the WTRU may report the associated ID proactively (e.g., without receiving a request from the network). Examples of trigger conditions to report the associated ID are as follows. For instance, the WTRU may determine to report the WTRU condition if the WTRU condition changes since the last occasion the WTRU reported the WTRU condition. The WTRU may report an associated ID to the network where the associated ID corresponds to the WTRU condition. The WTRU may report the associated ID to the network if the associated ID is different from the associated ID reported at the last occasion. For instance, the WTRU may determine to report the WTRU condition if the WTRU condition changes compared to the WTRU condition at the reference time. The WTRU may receive, from the network, information about the reference time (e.g., absolute time, SFN, and/or relative time). The WTRU may receive a request, from the network, to record the WTRU location at the reference time. For instance, the WTRU may determine to report the WTRU condition if the change in the WTRU condition is greater than a configured threshold compared to the last occasion the WTRU reported the WTRU condition or reference time. For example, the WTRU may be configured with a threshold for WTRU orientation (e.g., expressed in terms of degrees, radians). For instance, the WTRU may determine to report an associated ID if elapsed time since the last occasion the WTRU reported an associated ID and/or reference time is greater than a configured threshold. The WTRU may determine to report an associated ID when the elapsed time since the last occasion the WTRU reported and/or reference time is greater than the configured threshold and the associated ID is different from the reported or recorded associated IDs. In one example, the WTRU may start a timer to determine the elapsed time.

In one example, the WTRU may determine to flush the reported associated ID(s) after a certain amount of time. The WTRU may associate a timestamp with the reported associated ID. The WTRU may determine to remove the reported associated ID from the set if the elapsed time since the associated timestamp is greater than the configured threshold (e.g., N minutes, N hours, N days).

In one example, the WTRU may determine to report the associated ID after a certain amount of time elapsed since the last occasion the WTRU reported the associated ID. The WTRU may determine to do so to indicate to the network that the WTRU condition has been consistent. The WTRU may receive a time threshold (e.g., N symbols, N seconds, N slots) from the network. The WTRU may determine to report the associated ID if the elapsed time is greater than the configured threshold.

In one example, the WTRU may determine to reuse the associated ID, which was reported, to indicate a new WTRU condition. This may happen if the WTRU does not have enough associated IDs to indicate a variety of a WTRU condition. In this case, the WTRU may indicate to the network that the reported associated ID corresponds to a new condition.

In one example, the WTRU may determine to associate a WTRU condition (e.g., associated ID) with a time window. The WTRU may receive configurations for a time window (e.g., duration, start and/or end time). The WTRU may receive a request, from the network, to associate the associated ID with a time window. The WTRU may determine to indicate or report to the network an associated ID associated with a time window. The WTRU may report to the network the duration, start and/or end time of the window. In this case, the WTRU is indicating to the network that the WTRU will maintain a certain condition associated with the associated ID during start and end time. In another example, the WTRU may receive a request from the network to report the WTRU condition indicator (e.g., associated ID) prior to the start of the window or at the beginning of the window (e.g., first slot, first symbol, first frame within the window).

In one example, the WTRU may receive a request to report the WTRU condition retroactively. For example, the WTRU may report an associated ID associated with a time window whose start and/or end time may be before the current time. In another example, the WTRU may receive a request to report the WTRU conditions at the last N time occasions. Examples of the time occasions may be occasions the WTRU transmitted SRS. In another example, the WTRU may report the WTRU conditions at the past time instances (e.g., absolute time, relative time with respect to the reference time) indicated by the network. The WTRU may receive information about the time occasions (e.g., absolute time, relative time) from the network.

In one example, the WTRU may report more than one condition (e.g., more than one associated IDs) to the network indicating a combination of WTRU conditions. In one example, the WTRU may receive a request to maintain a certain WTRU condition (e.g., associated ID) during an indicated time window or time instances. The WTRU may respond to the request to the network, indicating that the WTRU can maintain the condition during the indicated time instance(s) or time window.

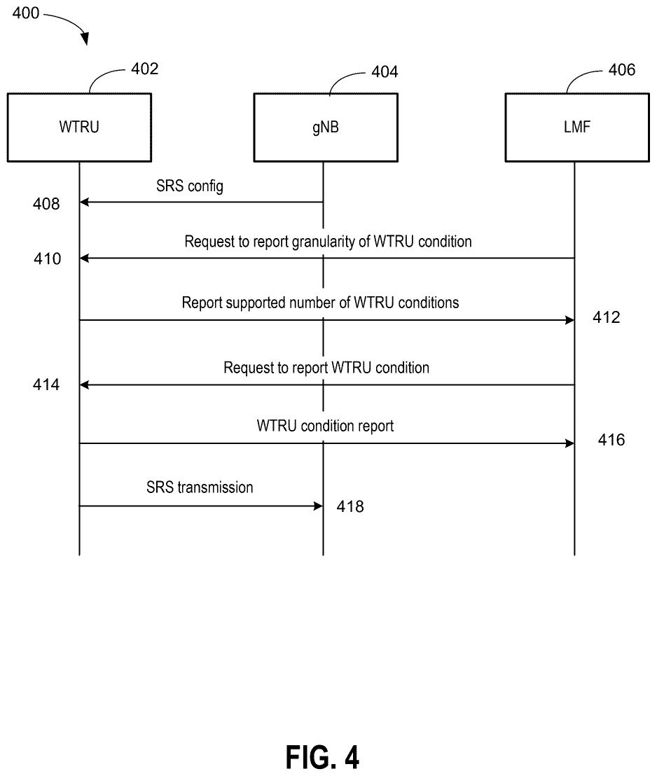

FIG. 4 is an example of signal exchange between the WTRU, gNB and LMF. In diagram 400 the WTRU 402 may receive SRS configurations 408 from the gNB 404. The WTRU 402 may receive a request 410, from the LMF 406, to report a granularity of WTRU conditions. The WTRU 402 may report the number of associated IDs 412 to the LMF 406. The WTRU 402 may receive a request 414, from the network 404 and/or LMF 406, to report the WTRU condition. The WTRU 402 may report the WTRU condition 416 via an associated ID to the LMF 406. The WTRU 402 transmits the configured SRS 418 and gNB makes measurements (e.g., timing, power, phase) on the received SRS.

WTRU condition and ground truth may be implemented. In some examples, the WTRU may receive a request from the network to report the ground truth (e.g., LOS status between WTRU and the indicated TRP, timing measurement, time of flight between WTRU and indicated TRP, time of flight for indicated DL-RS). The ground truth may be used by the network to train AI/ML models. The WTRU may receive a request to associate the WTRU condition indicator (e.g., associated ID, timestamp) with the ground truth, indicating the condition under which the WTRU determined the ground truth. In some examples, the WTRU may determine to associate the WTRU condition indicator with the ground truth where the WTRU condition indicator is from the set of reported WTRU condition indicators, indicating that the WTRU condition is the same or similar to one of the reported WTRU conditions. The set of reported WTRU condition indicator may include the WTRU conditions at the time of SRS transmission, or when the WTRU was requested by the network to record its condition.

Validity conditions of the WTRU condition indicator may be implemented. In one example, the WTRU may determine the validity condition of the WTRU condition indicator. The WTRU may be configured with validity condition associated with the WTRU condition indicator. If the WTRU determines that the reported WTRU condition is invalid, the WTRU may perform at least one of the following actions. For example, if the WTRU determines that the reported WTRU condition is invalid, the WTRU may report the WTRU condition. If the WTRU determines that the reported WTRU condition is invalid, the WTRU may send a request to the network to update the WTRU condition. If the WTRU determines that the reported WTRU condition is invalid, the WTRU may report to the network that the reported WTRU condition(s) is invalid. If the WTRU determines that the reported WTRU condition is invalid, the WTRU may stop reporting the WTRU condition if the WTRU receives a request to report the WTRU condition periodically or semi-persistently. If the WTRU determines that the reported WTRU condition is invalid, the WTRU may not report the WTRU condition if the WTRU receives a request to report the WTRU condition prior to the WTRU determining invalidity of the WTRU condition.

In some examples, the WTRU may be configured a time validity condition for the WTRU condition indicator. The WTRU may determine that the reported WTRU condition indicator is valid within the time limit. If the elapsed time is greater than the configured time threshold, the WTRU may determine to report the WTRU condition indicator.

In some examples, the WTRU may determine that the WTRU condition indicator is valid within an area (e.g., serving cell). The WTRU may be configured with the area validity condition (e.g., WTRU condition is valid within a serving cell, the WTRU condition is valid within an indicated area consisting of more than one cells). If the WTRU moves to another cell, the WTRU may determine that the reported WTRU condition is invalid and the WTRU may report the WTRU condition to the network.

In some examples, the WTRU may determine that the reported WTRU condition indicator is invalid if the WTRU changes its state (e.g., RRC_CONNECTED to INACTIVE) and/or the WTRU performs initial access. In another example, the WTRU may determine that the WTRU condition indicator the reported WTRU condition indicator is invalid if configurations are updated (e.g., Timing Advance (TA) value, DL-RS or UL-RS configurations).

WTRU condition and SRS transmission may be implemented. In some examples, the WTRU may be configured to transmit SRS. The WTRU may receive SRS configuration (e.g., SRS resource ID) and the WTRU may receive an indication which SRS(s) to transmit. The WTRU may receive configurations (e.g., periodicity) to transmit SRS periodically, semi-persistently or dynamically.

In some examples, the WTRU may report the WTRU condition (e.g., associated ID) with a SRS configuration parameter (e.g., SRS resource IDs and/or SRS resource set ID), indicating that the condition corresponding to the WTRU condition will be maintained for the indicated SRS configurations. In another example, the WTRU may report association between a SRS configuration parameter and configurations for a time window associated with the WTRU condition (e.g., associated ID), indicating that the WTRU condition will be maintained for the SRS configuration parameter during the indicated time window.

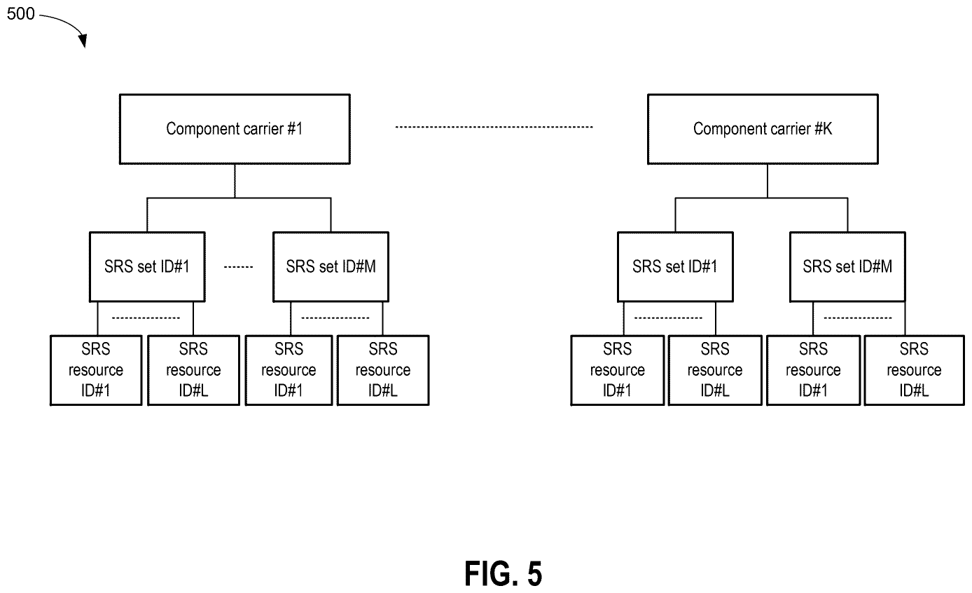

The SRS configuration may be organized in a hierarchical manner. For example, if the WTRU associates the WTRU condition with a SRS configuration parameter, the WTRU may determine to maintain the same WTRU condition for the parameters at a lower layer than the SRS configuration parameter. For example, if an SRS resource ID(s) belongs to an SRS resource set ID, and the WTRU associates the WTRU condition with the SRS resource set ID, the WTRU may also maintain the same condition for the SRS resource IDs that belong to the SRS resource set ID. FIG. 5 is an example of the hierarchical structure of SRS parameters. In diagram 500, each of SRS resource set and SRS resource is associated with an ID. More than one SRS resource sets may be associated with a component carrier ID. In one example, the WTRU may determine to associate a WTRU condition (e.g., associated ID) to a component carrier ID. The WTRU may determine to retain the same condition for SRS configuration parameters associated with the component carrier ID (e.g., SRS resource set IDs and/or SRS resource IDs). A frequency layer ID, center frequency information, frequency band information, or a component carrier ID may be used interchangeably.

In some examples, the WTRU may determine to transmit SRS based on the relative difference in the WTRU condition (e.g., associated ID) compared to the last occasion the WTRU reported the WTRU condition. For example, if the WTRU determines that the WTRU condition has not changed since the last occasion the WTRU reported its condition to the network, the WTRU may determine to transmit the configured SRS (e.g., configured SRS resource ID). In another example, the WTRU may determine that the WTRU condition has not changed since the last occasion the WTRU transmitted the SRS. In this case, the WTRU may determine to transmit the SRS since the condition has not changed. The WTRU may cancel transmission of SRS if at least one of the following conditions is satisfied. For instance, the WTRU may cancel transmission of SRS if the WTRU condition has changed since the last occasion the WTRU reported the WTRU condition, and/or the WTRU condition has changed since the last occasion the WTRU transmitted SRS. The WTRU may report the cause of cancellation of the SRS (e.g., mismatch in the WTRU condition). The WTRU may determine to report the WTRU condition indicator(s) when the WTRU determines to cancel transmission of the SRS.

In some examples, the WTRU may be configured with a threshold based on which the WTRU determines a change in the WTRU condition. For example, the WTRU may be configured with a threshold in degrees. If the change in WTRU orientation, since the last occasion the WTRU transmitted SRS and/or reported the WTRU condition, is above the configured threshold, the WTRU may determine that the WTRU condition has changed. In another example, if the WTRU changed the Tx panel for transmission of the configured SRS since the last occasion the WTRU transmitted SRS or reported the WTRU condition, the WTRU may determine that the WTRU condition has changed. The WTRU may indicate, to the network, which WTRU condition (e.g., Tx panel, WTRU orientation) has changed. In one example, if the WTRU canceled transmission of SRS transmission since the WTRU condition has changed, the WTRU may report, to the network, the WTRU condition (e.g., associated ID).

In some examples, the WTRU may determine whether to transmit the configured SRS based on whether there is consistency between the WTRU conditions at the current time instance and reference time instance.

In some examples, the WTRU may be configured with a reference time with respect to which the WTRU determines the consistency in the WTRU condition. It may be preferrable for the WTRU to transmit SRS under the same condition at the reference time. The WTRU may be configured with a reference point with respect to which the WTRU determines consistency in the WTRU condition and the WTRU transmits the configured SRS if the WTRU determines that the WTRU condition is consistent.

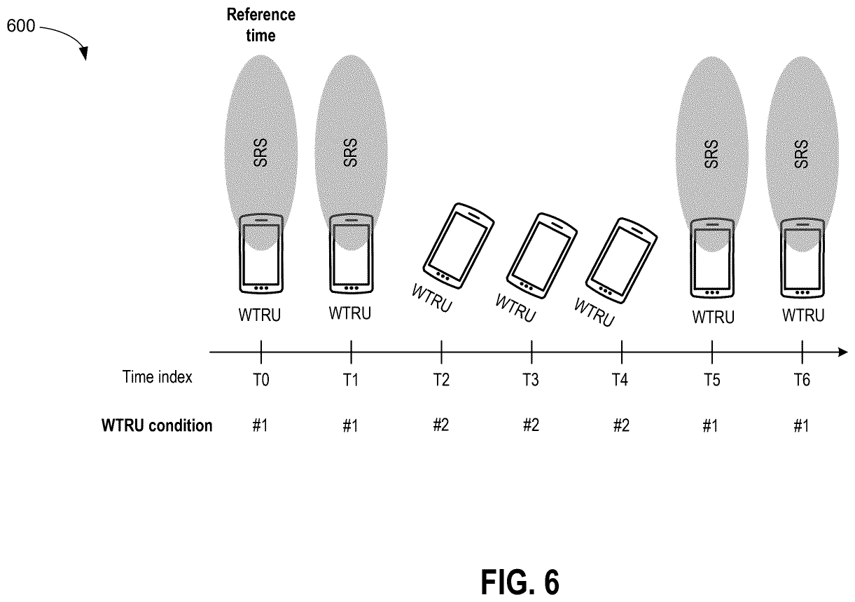

FIG. 6 is an example of determination of SRS transmission based on consistency in WTRU conditions using the reference point and where the WTRU is configured to transmit SRS. In diagram 600, the WTRU may be configured, by the network, with a reference time, TO (e.g., indicated by the network, system time, absolute time, SFN, SFNO, frame index, subframe index, slot index, symbol index). The WTRU records the WTRU condition (e.g., WTRU orientation) at the reference time TO, which is denoted by the WTRU condition #1 (e.g., associated ID #1) in the figure. The WTRU may report the WTRU condition indicator corresponding to the WTRU condition. The WTRU determine to transmit SRS if at the time of transmission, the WTRU condition is equal or similar to the WTRU condition at the reference time. For example, the WTRU determines to transmit SRS at time T1, T5 and T6 since the WTRU condition at each time instance is WTRU condition #1. The WTRU determines not to transmit or cancel transmission of SRS at time T2, T3 and T4 since the WTRU condition is different from the WTRU condition at the reference time. The WTRU may report, to the network, the WTRU condition at the reference time. The WTRU may report the WTRU condition (e.g., associated ID) when the WTRU determines to cancel transmission of the configured SRS.

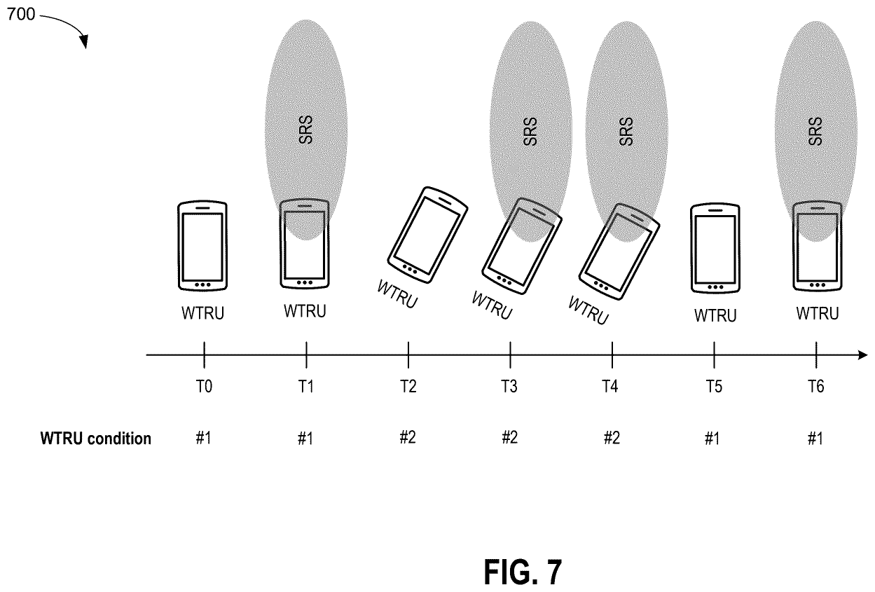

In another example, the WTRU may compare the current WTRU condition with the previous time instance. FIG. 7 is an example where the WTRU determines consistency of the WTRU condition based on the last occasion. For example, in diagram 700 the WTRU may determine to transmit SRS at time T1, T3, T4 and T6 since the WTRU condition (e.g., WTRU orientation) is same as the previous time occasion. The WTRU may not transmit SRS at time TO, T2 and T5 because either the WTRU condition was not consistent with the previous occasion and/or the WTRU is not configured with the time instance to compare the WTRU condition.

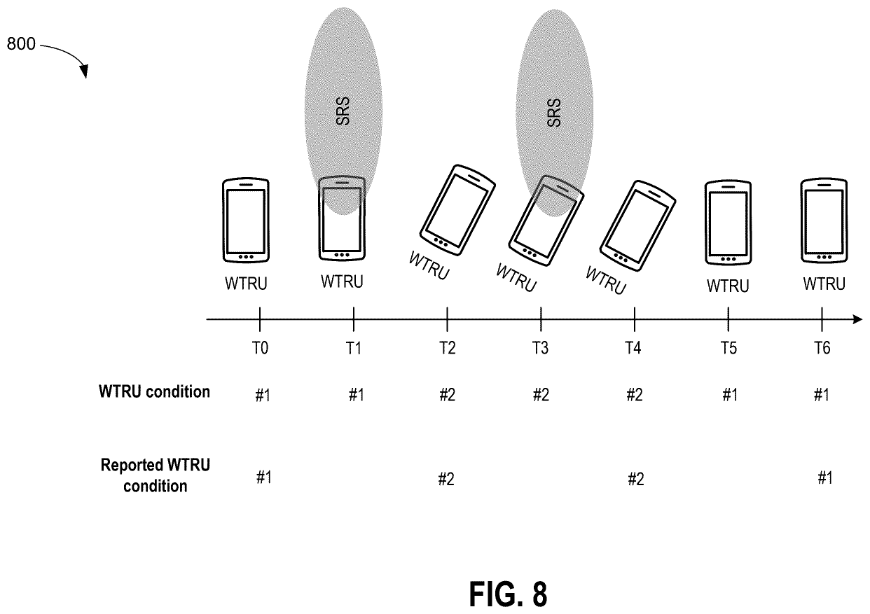

FIG. 8 is another example of determination of consistency. In diagram 800, the WTRU may determine to transmit the configured SRS if the WTRU condition at the time of transmission of the SRS is similar or same as the last occasion the WTRU reported the WTRU condition. For example, the WTRU may be configured to report the WTRU condition at TO (e.g., associated ID #1), T2, T4 and T6. The WTRU may be configured to transmit at T1, T3 and T5. At T3, the WTRU may determine that the WTRU condition at T3 is similar to the reported WTRU condition at T2. The WTRU may determine to transmit the configured SRS at T1. At T3, the WTRU may determine that the WTRU condition at T3 (e.g., associated ID #2) is similar to the reported WTRU condition at T2. The WTRU may determine to transmit the configured SRS at T3. At T5, the WTRU may determine that the WTRU condition at T5 (e.g., associated ID #1) is different from the reported WTRU condition at T4. The WTRU may determine to cancel transmission of the configured SRS at T5.

In some examples, the WTRU may receive SRS configurations from the network. The WTRU may receive a request from the LMF to report the number of associated IDs the WTRU can support. The WTRU may report, to the LMF, the supported associated IDs (e.g., range of associated IDs). The WTRU may determine whether to transmit SRS based on the following. For instance, if the WTRU determines that the WTRU side condition is the same as the one of the reported associated IDs, the WTRU may transmit SRS and report the associated ID. For instance, if the WTRU determines that the WTRU side condition is different from the reported associated IDs, the WTRU may report the associated ID only. The WTRU may not transmit SRS.

In some examples, the WTRU may determine to transmit SRS during a time window during which the WTRU condition is maintained. For example, the WTRU may report to the network configurations for the time window (e.g., duration, start and/or end time), and associated ID, indicating that the WTRU will maintain the WTRU condition during the time window. The WTRU may also indicate associated SRS configurations (e.g., SRS resource ID) with the time window indicating that the SRS will be transmitted during the time window. The SRS may be periodic, semi-persistent or aperiodic SRS. The WTRU may determine to stop transmission of the SRS after the time window is deactivated (e.g., via a deactivation command from the network, end of the time window).

In some examples, the WTRU may receive a request from the network to maintain the WTRU condition during a time window. The WTRU may receive a request to transmit the configured SRS during the time window. The WTRU may indicate or report, to the network, WTRU condition indicator(s) (e.g., associated ID) that can be associated with the time window.

In some examples, the WTRU may receive a WTRU condition indicator (e.g., associated ID), associated with the time window from the network, indicating the WTRU may need to maintain the WTRU condition that corresponds to the WTRU condition indicator. In this case, at least one of the following events may occur prior to receiving the indication from the network, associating the WTRU condition indicator with the time window. For example, the WTRU may receive WTRU condition indicators (e.g., associated IDs) from the network and a table mapping WTRU conditions (e.g., orientation, beamforming techniques) and corresponding associated IDs. For example, the WTRU may report WTRU condition indicator(s) to the network. The network may use one of the reported WTRU condition indicators when associating the time window with a WTRU condition indicator.

In some examples, the WTRU may receive, from the network, information about the time window during which the WTRU is configured to transmit SRS. For example, the WTRU may receive an indication from the network that the SRS transmitted during the time window is for collecting training data to train the AI/ML model(s) at the network. For example, the WTRU may receive an indication from the network that the SRS transmitted during the time window is for generating inference using the trained AI/ML model(s) at the network.

In some examples, the WTRU may determine to prioritize or deprioritize transmission of SRS for AI/ML purposes. For example, the WTRU may be configured to transmit SRS such that the network can train its AI/ML model(s) with SRS measurements. The WTRU may receive an indication from the network that the configured SRS is used for AI/ML model training and/or inference generation. If there is a collision in the frequency and/or time domain between SRS for AI/ML purpose and other UL signals (e.g., SRS for communication, SRS for positioning, DM-RS, PT-RS) or UL channels (e.g., PUCCH, PUSCH), the WTRU may determine to prioritize or deprioritize SRS for AI/ML purposes over other signals according to a configured rule(s) by the network (e.g., always prioritize SRS for AI/ML purposes).

In some examples, the WTRU may receive SRS configurations from the network. The WTRU may receive a request (e.g., from the LMF) to report the number of associated IDs (e.g., identifiers) the WTRU can support. The WTRU may report (e.g., to the LMF), the supported associated IDs (e.g., range of associated IDs). The WTRU may report a first set of associated IDs (e.g., composed of one or more associated IDs), with each associated ID corresponding to a different WTRU condition from a first set of WTRU conditions. The first set of associated IDs and the first set of WTRU conditions may be the empty set and may not be reported. The WTRU may receive a request to report a second WTRU condition (e.g., from the LMF). For instance, if the second WTRU condition is the same as one of the WTRU conditions from the first set of WTRU conditions, the WTRU may report the corresponding associated ID from the first set of associated IDs. For instance, if the second WTRU condition is different from all the WTRU conditions from the first set of WTRU conditions, the WTRU may report an associated ID that is different from the one or more associated IDs in the first set of associated IDs. The WTRU may add the reported associated ID to the first set of associated ID and may add the corresponding second WTRU condition to the first set of WTRU conditions. In some examples, the WTRU may determine whether to transmit SRS based on the following rules. For instance, the WTRU may transmit SRS if the second WTRU condition is the same as one of the WTRU conditions from the first set of WTRU conditions. For instance, the WTRU may not transmit SRS if the second WTRU condition is different from all the reported WTRU conditions from the first set of WTRU conditions. The WTRU may transmit SRS according to the SRS configuration (e.g., based on the determination to transmit SRS).

In some examples, the WTRU may determine to associate its condition with a timestamp. For example, when the WTRU receives a request to report its condition, the WTRU may report the timestamp that corresponds to the WTRU condition. In some examples, the WTRU may receive a WTRU condition indicator from the network with which the WTRU associates its condition.

Determination of WTRU conditions based on timestamps may be implemented. In some examples, the WTRU may receive a request from the network to record, store and/or associate the WTRU condition at the time of the request. The WTRU may associate the WTRU condition with a timestamp (e.g., absolute time, system time, relative time with respect to a reference time, SFN, frame index, slot index, symbol index, subframe index, etc.). The WTRU may determine to associate the WTRU condition with a timestamp if it is the condition which was never associated with a timestamp. The WTRU may determine not to associate the WTRU condition with a timestamp if the condition was already associated with another timestamp. When the WTRU associates the WTRU condition with a timestamp, the WTRU may report the timestamp to the network to indicate that a new condition has been recorded.

In one example, the WTRU may report whether the WTRU condition is the same as that of a network indicated past timestamp. In some examples, the WTRU may report the degree of a change of a current WTRU condition (e.g., indicating the WTRU condition that has changed) with respect to the WTRU condition of a past timestamp (e.g., network indicated past timestamp). For example, the WTRU may receive a request, from the network, to report the type of change and the degree of the change. An example of the type of change may be orientation angle, beamforming methods (e.g., analogue beamforming, digital beamforming, etc.), panel location, etc. For example, the degree of change may be expressed in degrees of orientation, used beamforming technique, change in the location of antenna panels, etc.

In some examples, the WTRU may receive a request to report the WTRU condition. The WTRU may report the timestamp which corresponds to the WTRU condition. The WTRU may report the timestamp that is associated with the WTRU condition. The WTRU may report the timestamp at which the WTRU received the request from the network to report if the WTRU condition, at the time of reporting, has not been reported in the past.

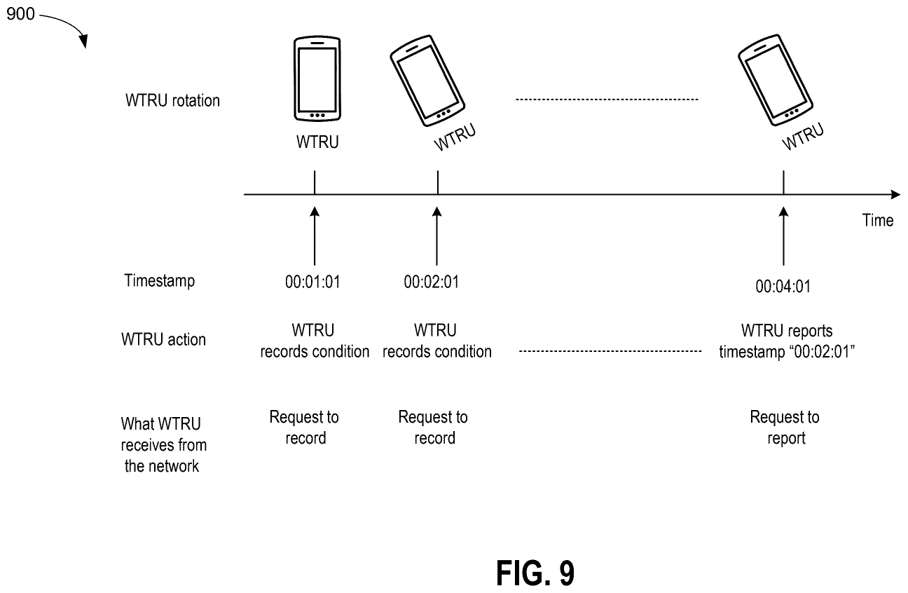

FIG. 9 is an example illustration of reporting WTRU side condition with a timestamp. In diagram 900, there are three time instances, indicated by three different timestamps. At the first time instance, with a timestamp “00:01:01”, the WTRU may receive a request from the network to record the WTRU condition (e.g., WTRU orientation). The WTRU may determine to associate the WTRU condition to the timestamp “00:01:01” since the condition was never associated with a timestamp. At a timestamp “00:2:01”, the WTRU may receive a request to record the WTRU condition. The WTRU may determine to associate the WTRU condition with the timestamp “00:02:01” since the WTRU condition was never associated with the timestamp. At a timestamp “00:04:01”, the WTRU may receive a request to report the WTRU condition. Since the WTRU condition at the time instance is similar to the condition at “00:02:01”, the WTRU may report, to the network, the timestamp “00:02:01”.

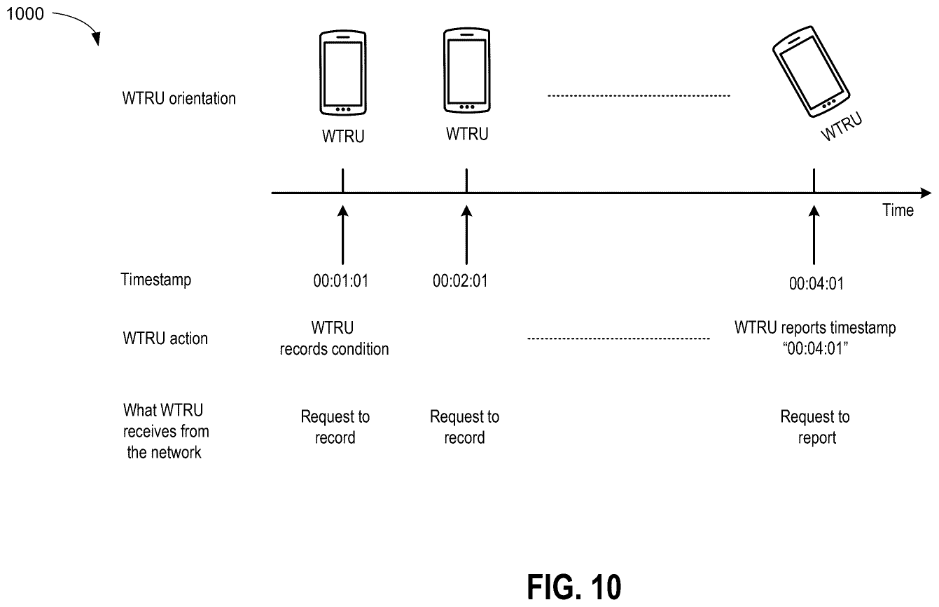

FIG. 10 is another example illustration of reporting WTRU side condition with a timestamp. As shown in diagram 1000, at the first time instance, with a timestamp “00:01:01”, the WTRU may receive a request from the network to record the WTRU condition (e.g., WTRU orientation). The WTRU may determine to associate the WTRU condition to the timestamp “00:01:01” since the condition was never associated with a timestamp. At a timestamp “00:02:01”, the WTRU may receive a request to record the WTRU condition. The WTRU may determine not to record the WTRU condition since the WTRU condition is the same as the condition recorded at “00:01:01”. At a timestamp “00:04:01”, the WTRU may receive a request to report the WTRU condition. Since the WTRU condition at the time instance has not been recorded, the WTRU may report to the network the timestamp “00:04:01”.

In some examples, the WTRU may receive a request from the network to start a timer. The WTRU may determine the timestamp based on the value of the timer. In another example, the WTRU may receive information about a reference time (e.g., begging of a radio frame, SFNO, etc.) from the network, based on which the WTRU determines a timestamp. In another example, the WTRU may receive, from the network, an initial value for the timestamp. The WTRU may determine the timestamp based on the initial value and timer.

The WTRU may determine to reset and/or initialize the timestamp after an event. An example of initialization of a timestamp may be to set the timestamp to a configured and/or fallback value. Examples of such an event may be, but not limited, to at least one of the following. For example, the WTRU may determine to reset and/or initialize the timestamp after the WTRU receives a new and/or updated SRS configuration from the network. The WTRU may determine to reset and/or initialize the timestamp after the WTRU changes its connection status (e.g., from RRC_CONNECTED to IDLE or INACTIVE). The WTRU may determine to reset and/or initialize the timestamp after the WTRU is reconfigured and/or may determine(s) a new TA value. The WTRU may determine to reset and/or initialize the timestamp after the WTRU performs initial access. The WTRU may determine to reset and/or initialize the timestamp after the WTRU receives a new and/or updated initial value for the timestamp. The WTRU may determine to reset and/or initialize the timestamp after the WTRU receives and/or is configured with an alternative indicator to associate the WTRU condition (e.g., associated ID). The WTRU may determine to reset or initialize the timestamp after elapsed time since the last time the timestamp was initialized is over a configured threshold.

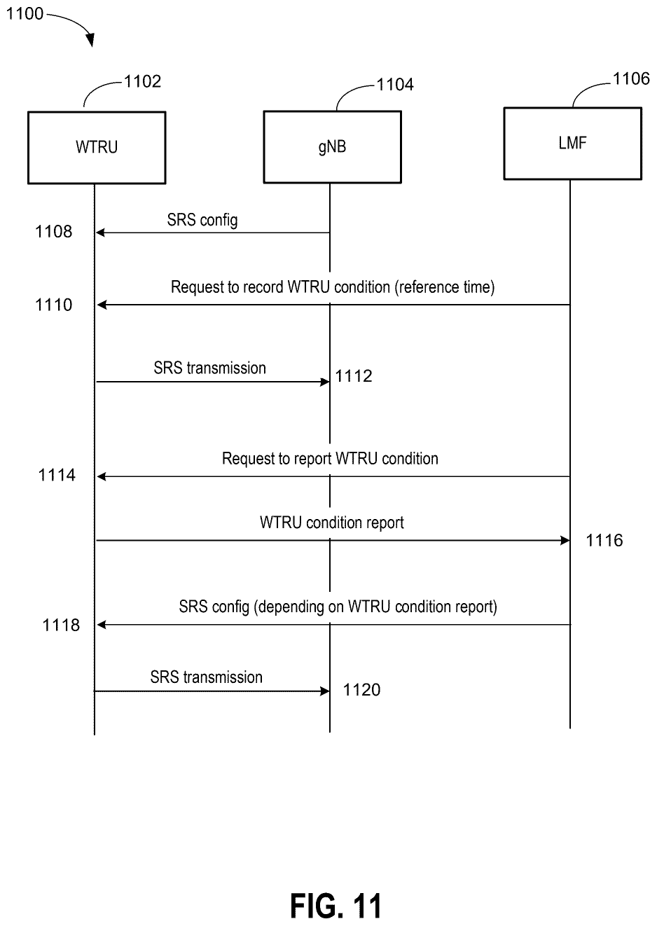

FIG. 11 is an example of signal exchange between the WTRU 1102, gNB 1104 and LMF 1106 (e.g., a procedure for reporting the WTRU condition with a timestamp). In diagram 1100, the WTRU 1102 may receive SRS configuration 1108 from the gNB 1104. The WTRU 1102 may receive a request 1110 from the LMF 1106 to record the WTRU condition. The WTRU 1102 may transmit the configured SRS 1112 to the gNB. The WTRU 1102 may receive a request 1114 from the LMF 1106 to report the WTRU condition. The WTRU 1102 may report its condition 1116 via a timestamp. Depending on the reported condition, the WTRU 1102 may receive SRS configurations 1118 from the network 1104 and/or LMF 1106. The WTRU 1102 may transmit SRS 1120 according to the received configuration.

In some examples, the WTRU may receive the granularity for the timestamp with which the WTRU associates its condition. Examples of granularity of the timestamp may be by seconds, hours, days, symbols, slots, frames, subframes, SFN, etc. The WTRU may need to record its WTRU condition more precisely the finer the granularity. In some examples, the WTRU may receive a request, from the network, to report the supported granularity for the timestamp. The WTRU may report, to the network, supported granularity for the timestamp. The WTRU may determine the supported granularity based on the WTRU capability (e.g., memory, UE conditions).

In some examples, the WTRU may report to the network, indicating that the WTRU condition N time units before and/or after the timestamp. Such information may be conveyed via a validity time range. The WTRU may receive configurations for a validity time range of a timestamp. For example, the validity time range may be N minutes. The WTRU may report the timestamp along with the validity time range, indicating to the network that the WTRU condition was consistent N minutes before and after the timestamp.

In some examples, the WTRU may receive a request from the network to associate explicit WTRU condition(s) with an indicator (e.g., timestamp, associated ID, etc.). For example, the WTRU may receive a request from the network to associate WTRU orientation, WTRU location and hardware used to transmit SRS to an indicator (e.g., timestamp).

Determination of WTRU conditions based on an indicator configured by the network may be implemented. In some examples, for each request sent by the network to record the WTRU condition, the WTRU may receive an indicator from the network to associate the UE condition. When the WTRU receives a request to report the WTRU condition, the WTRU may report the indicator. An example of an indicator may be, but not limited, one of the following. For example, an indicator may be an index. An indicator may be an ID. An indicator may be an indicator. An indicator may be a timestamp. If the WTRU associated a new WTRU condition with the indicator, the WTRU may report to the network that a WTRU condition has been associated with the indicator.

If the WTRU has already associated the WTRU condition with an indicator, the WTRU may perform at least one of the following actions. For example, if the WTRU has already associated the WTRU condition with an indicator the WTRU may not report to the network that the indicator has been associated with a WTRU condition. For example, if the WTRU has already associated the WTRU condition with an indicator the WTRU may report to the network that the current WTRU condition has already been associated with an indicator. When the WTRU receives a request to report the WTRU condition, the WTRU may report, to the network, the indicator that corresponds to the WTRU condition.

In some examples, the WTRU may receive SRS configurations from the network. The WTRU may receive a request for recording the WTRU condition from the LMF. For example, the WTRU may receive a request for recording the WTRU condition at reference time instances (e.g., each time instance associated with a timestamp). The WTRU may receive a timestamp. For example, the request may contain details the WTRU needs to record the associated condition (e.g., SRS resource, spatial condition).

The WTRU may transmit SRS according to the SRS configuration. The WTRU may receive a request to report WTRU condition. The WTRU may report one or more timestamps where the corresponding recorded WTRU condition are the same as the current WTRU condition. If the current WTRU condition are not the same as any recorded WTRU conditions, the WTRU may report the new and/or current timestamp. In some examples, the WTRU reports whether the WTRU condition is the same as that of a network indicated past timestamp. In some examples, the WTRU may report the degree of a change of a current WTRU condition (e.g., indicating what changed) with respect the WTRU condition of a past timestamp (e.g., network indicated past timestamp).

In some examples, the WTRU may determine the change in WTRU condition between the WTRU condition at inference time and the WTRU condition of a current or past timestamp (e.g., network indicated timestamp). For example, the WTRU may determine a change in WTRU orientation.

The WTRU may compare the determined change in WTRU condition to a threshold. The WTRU may indicate (e.g., to the network) whether the determined change in WTRU conditions is greater than or less than the threshold. The WTRU may stop transmission of periodic SRS if the determined change in WTRU conditions is greater than a threshold.

By implementing the methods discussed herein, the network may be able to train AI/ML models and use them to generate inference consistently, ensuring consistent performance of the AI/ML model.

1. A wireless transmit/receive unit (WTRU) comprising:
a processor configured to:
receive configuration information from a network, wherein the configuration information comprises a sounding reference signal (SRS) configuration;
receive a first request to report a number of identifiers that the WTRU supports, wherein each identifier is associated with a condition of the WTRU;
send a first report that indicates the number of identifiers that the WTRU supports;
send a second report that indicates a first set of identifiers, wherein each identifier in the first set of identifiers indicates a value associated with the condition of the WTRU;
receive a second request to report one or more conditions of the WTRU;
send a third report that indicates a second set of identifiers, wherein the second set of identifiers indicate whether one or more of the conditions of the WTRU have changed; and
determine whether to send an SRS transmission based on whether one or more of the conditions of the WTRU have changed.

2. The WTRU of claim 1, wherein the first set of identifiers further indicates an orientation of the WTRU, a location of the WTRU, a hardware device used by the WTRU, a hardware condition or status of the WTRU, a time synchronization source, absolute or relative location of transmission (Tx) or reception (Rx) panels, a time synchronization error at the WTRU, an angle of arrival (AoA) or angle of departure (AoD) alignment error at the WTRU, a phase alignment error at the WTRU, or beamforming techniques.

3. The WTRU of claim 2, wherein the hardware device comprises the Tx panel, the Rx panel, amplifiers or filters, wherein the hardware condition comprises an orientation of the Tx or Rx panel, wherein the time synchronization source comprises clock information from global navigation satellite system (GNSS) or clock information from the network, and wherein the time synchronization error at the WTRU comprises timing drift or timing jitter.

4. The WTRU of claim 1, wherein the first request to report a number of associated IDs is via a location management function (LMF).

5. The WTRU of claim 1, wherein the processor is configured to:
determine to transmit the SRS transmission if the one or more of the conditions of the WTRU have not changed.

6. The WTRU of claim 1, wherein the processor is configured to:
determine not to transmit the SRS transmission if the one or more of the conditions of the WTRU have changed.

7. The WTRU of claim 1, wherein the processor is configured to:
receive a third request to report the conditions of the WTRU at indicated time instances, wherein the indicated time instances comprise absolute time, relative time or system frame number (SFN).

8. The WTRU of claim 1, wherein the processor is configured to:
receive a third request to report the conditions of the WTRU periodically within a configured time window, wherein the configured time window comprises duration in terms of seconds, number of symbols, number of slots or number of frames.

9. A method performed by a wireless transmit/receive unit (WTRU), the method comprising:
receiving configuration information from a network, wherein the configuration information comprises a sounding reference signal (SRS) configuration;
receiving a first request to report a number of identifiers that the WTRU supports, wherein each identifier is associated with a condition of the WTRU;
sending a first report that indicates the number of identifiers that the WTRU supports;
sending a second report that indicates a first set of identifiers, wherein each identifier in the first set of identifiers indicates a value associated with the condition of the WTRU;
receiving a second request to report one or more conditions of the WTRU;
sending a third report that indicates a second set of identifiers, wherein the second set of identifiers indicate whether one or more of the conditions of the WTRU have changed; and
determining whether to send an SRS transmission based on whether one or more of the conditions of the WTRU have changed.

10. The method of claim 9, wherein the first set of identifiers further indicates an orientation of the WTRU, a location of the WTRU, a hardware device used by the WTRU, a hardware condition or status of the WTRU, a time synchronization source, absolute or relative location of transmission (Tx) or reception (Rx) panels, a time synchronization error at the WTRU, an angle of arrival (AoA) or angle of departure (AoD) alignment error at the WTRU, a phase alignment error at the WTRU, or beamforming techniques.

11. The method of claim 10, wherein the hardware device comprises the Tx panel, the Rx panel, amplifiers or filters, wherein the hardware condition comprises an orientation of the Tx or Rx panel, wherein the time synchronization source comprises clock information from global navigation satellite system (GNSS) or clock information from the network, and wherein the time synchronization error at the WTRU comprises timing drift or timing jitter.

12. The method of claim 9, wherein the first request to report a number of associated IDs is via a location management function (LMF).

13. The method of claim 9, wherein the method comprises:
determining to transmit the SRS transmission if the one or more of the conditions of the WTRU have not changed.

14. The method of claim 9, wherein the method comprises:
determining not to transmit the SRS transmission if the one or more of the conditions of the WTRU have changed.

15. The method of claim 9, wherein the method comprises:
receiving a third request to report the conditions of the WTRU at indicated time instances, wherein the indicated time instances comprise absolute time, relative time or system frame number (SFN).

16. The method of claim 9, wherein the method comprises:
receiving a third request to report the conditions of the WTRU periodically within a configured time window, wherein the configured time window comprises duration in terms of seconds, number of symbols, number of slots or number of frames.
